(19) United States
(12) Patent Application Publication
(10) Pub. No.: US 2014/0144387 A1
(43) Pub. Date: May 29, 2014

(54) PAPER-MADE COMPOSITE PET HOUSE

(71) Applicant: Pin-Yao CHANG, Hsinchu City (TW)

(72) Inventor: Pin-Yao CHANG, Hsinchu City (TW)

(21) Appl. No.: 13/687,981

(22) Filed: Nov. 28, 2012

(51) Int. Cl. A01K 1/03

(52) U.S. Cl. CPC A01K 1/03
USPC 119/482

(57) ABSTRACT

A paper-made composite pet house comprises a rigid bottom cardboard, at least one cardboard support wall connected to the rigid bottom cardboard, a cardboard cover, a top coupling wall and at least one viewing tower. The rigid bottom cardboard has a first coupling portion. The cardboard support wall has a second coupling portion connecting to the first coupling portion and a plurality of top coupling portions remote from the rigid bottom cardboard. The cardboard cover is remote from the rigid bottom cardboard and connected to the top coupling portions to form a mask cover. The top coupling wall and viewing tower are located on the cardboard cover. Thus the invention allows users to assemble by themselves and is flexible in shape. It also is eco-friendly, and can be assembled quickly and fabricated at low cost to provide improved practicality.

### FIELD OF THE INVENTION

The present invention relates to a paper product and particularly to a paper-made composite pet house.

### BACKGROUND OF THE INVENTION

Pets such as cats and dogs have become many people's important companions in life. Many pet owners are willing to spend a lot of time and money to provide more comfort for their pets. For instance, pet houses assembled by extruded aluminum slats and coupling blocks are available on the market to provide dedicated shelters for pets. However, assembly of the extruded aluminum slats and the coupling blocks is difficult and takes more time. Moreover, the pet houses thus formed often are fixed in style and not changeable to suit user's desire, and also more costly, hence are not widely accepted on the market. There are also pet houses made of plastics on the market. They generally are formed via integrated injection at a greater size, and are relatively difficult in transportation, thus also are not well accepted by consumers. The most important of all, the aforesaid two types of pet houses are not eco-friendly and cannot meet the requirements of increasing awareness of environmental protection. When discarded, they create substantially negative impact to the environment, hence are against the prevailing trend.

### SUMMARY OF THE INVENTION

The primary object of the present invention is to solve the problems of conventional pet houses that are difficult and time-consuming in assembly and disassembly.

Another object of the invention is to solve the problem of the conventional pet houses that is not eco-friendly.

Yet another object of the invention is to enhance flexibility in assembling pet houses to better meet users' requirements.

To achieve the foregoing objects, the present invention provides a paper-made composite pet house that comprises a rigid bottom cardboard, at least one cardboard support wall, a cardboard cover coupled with the cardboard support wall, a top coupling wall vertically connected to one side of the cardboard cover remote from the cardboard support wall, and at least one viewing tower located on the cardboard cover. The rigid bottom cardboard includes at least one edge and a first coupling portion on the edge. The cardboard support wall is connected to the rigid bottom cardboard and includes a second coupling portion adjacent to the rigid bottom cardboard, a plurality of top coupling portions remote from the rigid bottom cardboard and an opening. The second coupling portion is fixedly connected to the first coupling portion. The opening is adjacent to the rigid bottom cardboard. The cardboard cover is connected to the top coupling portions to form a mask cover, and is incorporated with the rigid bottom cardboard and cardboard support wall to form a housing compartment. The top coupling wall is located correspondingly to the cardboard support wall and has a plurality of protrusive portions at one side of the cardboard cover and spaced from each other. The viewing tower is located on the cardboard cover for ornamental purpose.

The paper-made composite pet house of the invention thus formed has features as follows:

1. The pet house is lighter in weight and more durable because of the characteristics of the rigid cardboard, and also can meet environmental protection requirements.

2. The pet house has a smaller size when not assembled so that is easier for transportation.

3. Assembly can be done quickly and easily to improve usability.

4. No need for mold making, hence the cost is lower.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a fragmentary exploded view of the invention.

FIG. 3 is another fragmentary exploded view of the invention.

### DETAILED DESCRIPTION OF THE PREFERRED EMBODIMENT

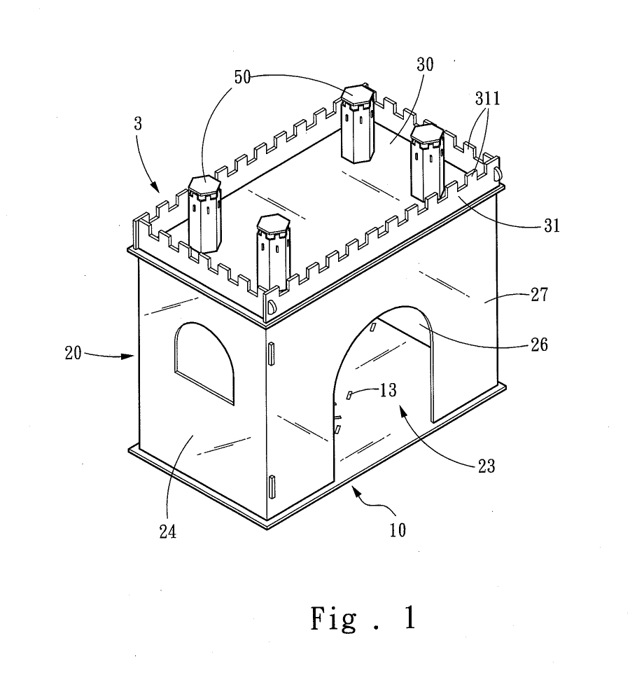

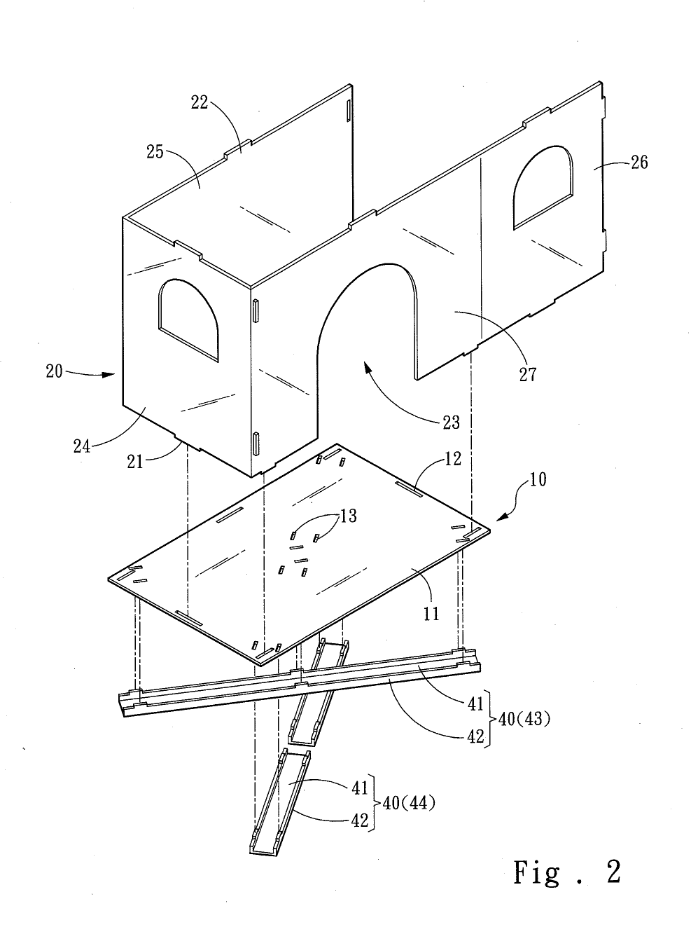

Please refer to FIGS. 1 and 2, the present invention aims to provide a paper-made composite pet house. It comprises a rigid bottom cardboard 10, at least one cardboard support wall 20 and a cardboard cover 30. The rigid bottom cardboard 10 includes at least one edge 11 and a first coupling portion 12 on the edge 11. The cardboard support wall 20 is connected to the rigid bottom cardboard 10 and includes a second coupling portion 21 adjacent to the rigid bottom cardboard 10, a plurality of top coupling portions 22 remote from the rigid bottom cardboard 10 and an opening 23. The second coupling portion 21 is fixedly connected to the first coupling portion 12. The opening 23 is adjacent to the rigid bottom cardboard 10. The cardboard cover 30 is connected to the top coupling portions 22 to form a mask cover 3. The cardboard cover 30 is incorporated with the rigid bottom cardboard 10 and cardboard support wall 20 to form a housing compartment.

In this embodiment, the rigid bottom cardboard 10 is quadrilateral and has four edges 11. There are four cardboard support walls 20 defined as a first wall 24, a second wall 25, a third wall 26 and a fourth wall 27. The fourth wall 27 is connected to the first wall 24. The opening 23 is formed on the fourth wall 27. It is to be noted that the “cardboard” means paper material formed with desired rigidity, such as a corrugated cardboard or other types of rigid cardboards.

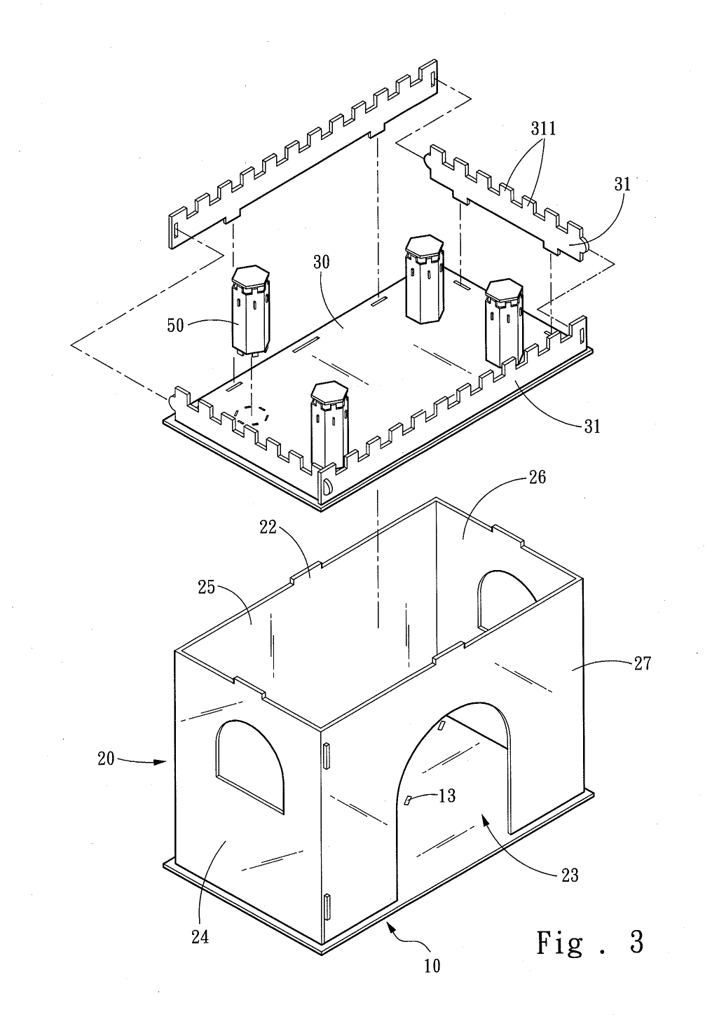

Also referring to FIG. 2, the first coupling portion 12 is a notch, and the second coupling portion 21 is a jutting ledge insertable into the first coupling portion 12 to form perpendicular positioning. Please refer to FIG. 3, a top coupling wall 31 is located correspondingly to the cardboard support wall 20. The top coupling wall 31 has a plurality of protrusive portions 311 on one side of the cardboard cover 30 and spaced from each other, thereby a castle-like ornamental effect is formed. The invention further has at least one viewing tower 50 located on the surface of the cardboard cover 30. In this embodiment, there are four viewing towers 50 located at four positions of the cardboard cover 30 relative to each other to look like viewing towers on the castle to achieve better visual appeal. Holistically, through the design of the protrusive portions 311 of the top coupling wall 31 incorporating with the viewing tower 50, the pet house of the invention differs from the conventional ones.

In order to prevent the rigid bottom cardboard 10 from being damped and softened due to the wet floor, the invention further provides at least one raising member 40 on one side of the rigid bottom cardboard 10 remote from the cardboard support wall 20 to increase the distance between the rigid bottom cardboard 10 and the ground surface. More specifically, referring to FIG. 2, the rigid bottom cardboard 10 has a plurality of apertures 13. The raising member 40 has a base 41 and two opposite side walls 42 connecting to the base 41 to fixedly insert into the apertures 13. In this embodiment, there are three raising members 40 including a longer raising member 43 and two shorter raising members 44 at two sides of the longer raising member 43 to form an X shape therewith, thereby the rigid bottom cardboard 10 is formed in a steadier structure. Thus the rigid bottom cardboard 10 is lifted from the ground surface without directly contacting with water on the ground surface, hence can avoid the softening problem.

As a conclusion, compared with the conventional techniques, the invention provides many desirable features, notably:

1. The pet house thus formed is lighter in weight and more durable because of the characteristics of the rigid cardboard, and also is more eco-friendly.

2. The pet house has a smaller size when not assembled so that is easier for transportation.

3. Assembly can be done quickly and easily to improve usability.

4. No need for mold making, hence the cost is lower.

5. With the raising member, the pet house is prevented from directly contacting the ground surface, hence the rigid bottom cardboard is less likely to contact with water to be softened.

In short, the present invention provides significant improvements over the conventional pet houses.

While the preferred embodiment of the invention has been set forth for the purpose of disclosure, it is not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A paper-made composite pet house, comprising:
a rigid bottom cardboard including at least one edge and a first coupling portion on the edge;
at least one cardboard support wall which is connected to the rigid bottom cardboard and includes a second coupling portion adjacent to the rigid bottom cardboard, a plurality of top coupling portions remote from the rigid bottom cardboard and an opening, the second coupling portion being fixedly connected to the first coupling portion, the opening being adjacent to the rigid bottom cardboard;
a cardboard cover which is connected to the cardboard support wall and connected to the plurality of top coupling portions to form a mask cover, the cardboard cover being incorporated with the rigid bottom cardboard and the cardboard support wall to form a housing compartment;
a top coupling wall which is vertically connected to one side of the cardboard cover remote from the cardboard support wall and is located correspondingly to the cardboard support wall, and includes a plurality of protrusive portions on the one side of cardboard cover and spaced from each other; and
at least one viewing tower located on the cardboard cover.

2. The paper-made composite pet house of claim 1 further including four cardboard support walls which are defined as a first wall, a second wall, a third wall and a fourth wall, the fourth wall connecting to the first wall and including the opening formed thereon, wherein the rigid bottom cardboard is quadrilateral and includes four edges.

3. The paper-made composite pet house of claim 1, wherein the first coupling portion is a notch and the second coupling portion is a jutting ledge.

4. The paper-made composite pet house of claim 1 further including at least one raising member on one side of the rigid bottom cardboard remote from the cardboard support wall to lift the rigid bottom cardboard to separate from a ground surface at a selected distance.

5. The paper-made composite pet house of claim 4, wherein the rigid bottom cardboard includes a plurality of apertures, the raising member including a base and two opposite side walls connecting to the base to fixedly insert into the plurality of apertures.
